(19) United States
(12) Patent Application Publication
(10) Pub. No.: US 2005/0216393 A1
(43) Pub. Date: Sep. 29, 2005

(54) Systems and methods for allowing market-maker participation in transactions

(76) Inventors: Howard W. Lutnick, New York, NY (US); Michael Sweeting, Aldershot (GB)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/090,558

(22) Filed: Mar. 23, 2005

Related U.S. Application Data
(60) Provisional application No. 60/555,542, filed on Mar. 23, 2004.

(51) Int. Cl. G06F 17/60

(52) U.S. Cl. 705/37

(57) ABSTRACT

Systems and methods for implementing transaction management of trading of financial instruments. The systems and methods provide controlling logic that is implemented on a distributed computer network linking together a plurality of user workstations. The controlling logic rewards market-makers by allowing them to participate in trading the instrument before or after the first buyers/sellers and contra-traders of the instrument and allowing broader participation in transacting the purchase and sale of different instruments.

### CROSS-REFERENCE TO RELATED APPLICATION

This application claims the benefit of U.S. provisional application No. 60/555,542, filed Mar. 23, 2004, which is hereby incorporated by reference herein in its entirety.

### BACKGROUND OF THE INVENTION

This invention relates to data processing systems and methods for assisting in financial transactions. More specifically, this invention relates to systems and methods for allowing market-maker participation in the managed trading of financial instruments.

Much trading today involves some computer support, from simple information delivery to sophisticated trading systems that automate transactions of goods and services. In recent years, electronic trading systems have gained widespread acceptance for trading of a wide variety of items ranging from financial instruments (such as stocks, bonds, currency, futures, options, etc.) to household goods (such as old records, antiques, wines, etc.) As electronic trading becomes more popular, an increasing number of traders are in need of new systems and methods to enter trade commands in a quick, efficient, and accurate manner. In one method of electronic trading, bids and offers are submitted by traders to a trading system, those bids and offers are then displayed by the trading system to other traders, and the other traders may then respond to the bids and offers by submitting sell (or hit) or buy (or lift) commands to the system.

Some implementations of such methods of electronic trading vest interactively matched buyers and sellers with the authority to hold up a trade at a desirable price for a defined time period. In such implementations, such first buyers and sellers are given the exclusive opportunity to trade during the defined time period. In other implementations, incentives such as reduced transaction costs and cash payments are provided for making markets based on characteristics such as price, size, duration, etc., of orders submitted to the trading system.

However, it would be desirable to provide systems and methods for giving a market-maker an opportunity to participate in the trading of these and other instruments at the desirable price, and allowing broader market-maker participation in transacting the purchase and sale of different instruments.

### SUMMARY OF THE INVENTION

It is therefore an object of this invention to provide systems and methods for allowing market-maker participation in the purchase and sale of instruments either prior to or after the matched buyers and sellers and allowing broader participation in transacting the purchase and sale of different instruments.

The above and other objects of the present invention are realized in a specifically delineated data processing system, such as an electronic trading system, having a governing program including controlling logic for managing select trading functionality. The data processing system includes a plurality of trading workstations linked to a server. The workstations may include keypads for facilitating user input. The server may implement the controlling logic which processes user input and dictates the trading options and screen displays on each workstations.

The controlling logic may reward a market-maker by presenting the market-maker with an opportunity to participate in trading at least a portion of a desired volume of an instrument with a contra-trader entering a bid or offer on the instrument or a first buyer/seller hitting or lifting the bid or offer at a defined price. The opportunity to participate in the trading may be to the exclusion of other participants during a defined period of time. The controlling logic may give the market-maker the opportunity to participate in trading the instrument with the first buyer/seller or contra-trader before or immediately after the other. The controlling logic may reward the market-maker by giving the market-maker the opportunity to participate in trading additional volume of the instrument with any participant before or immediately after the first buyer/seller or contra-trader.

The controlling logic may reward the market-maker by giving the market-maker the opportunity to ensure that an order placed by the market-maker maintains a predetermined position within a trading stack using predetermined price improvement levels. The controlling logic may reward the market-maker by giving the market-maker the opportunity to ensure that a bid or offer quote by the market-maker is given priority over other quotes in an electronic trading system.

The reward may be in the form of reward points, which may also be referred to as loyalty points, that are awarded to the market-maker based on the bid/offer received by the market-maker. These loyalty points may be redeemed for one or more of the above-mentioned or other opportunities. The number and/or class of loyalty points awarded may depend on the type of the instrument, the grade of the instrument, the volatility of the instrument, the liquidity of the instrument, the time of day during which the bid/offer was received, how long the bid/offer has been available, how much trading volume was directly attributable to a participation of the market-maker or any combination thereof.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram of an exemplary system that may be used to implement the processes and functions of certain embodiments of the present invention;

FIG. 2 shows a flow diagram for allowing market-maker participation in the purchase and sale of instruments according to certain embodiments of the present invention;

FIG. 3 is an illustration of a portion of an interactive display that may be displayed to users in accordance with certain embodiments of the present invention; and

FIG. 4 shows a flow diagram for rewarding market-makers according to certain embodiments of the present invention.

### DETAILED DESCRIPTION OF THE INVENTION

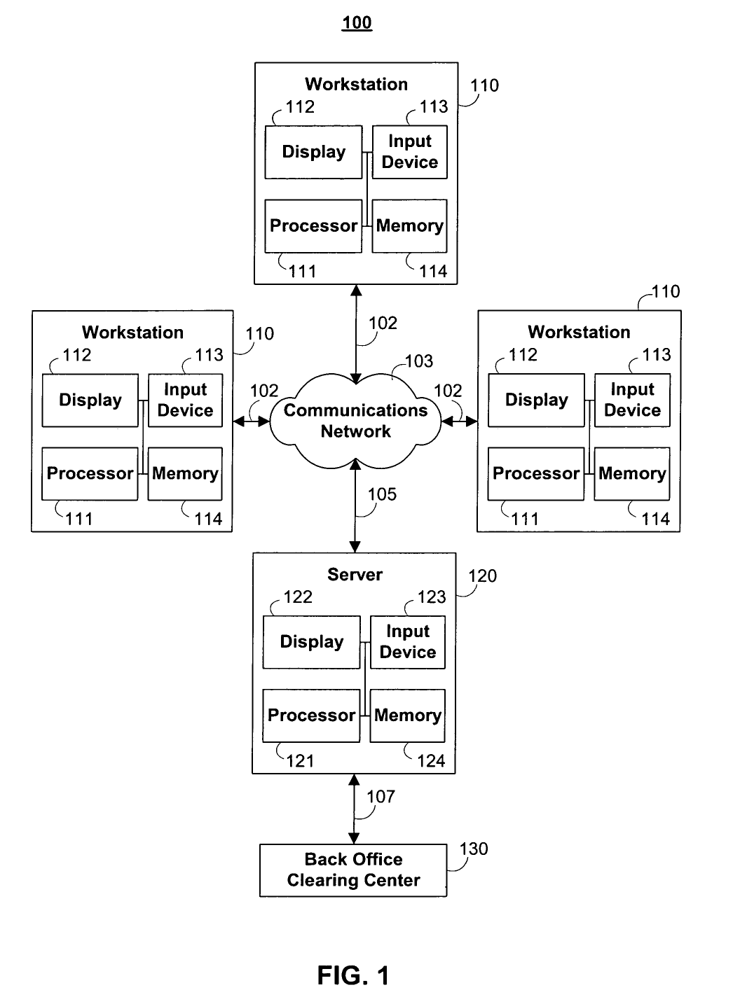

The present invention is directed to systems and methods for implementing transaction management of trading of items. The systems and methods provide controlling logic that is implemented on a distributed computer network linking together a plurality of user workstations, as shown in FIG. 1. The controlling logic which processes user input and dictates the trading options and screen displays on each workstations. The controlling logic also dictates which buyers and sellers are to participate in the transactions processed by the server. The controlling logic rewards market-makers by allowing them to participate in trading an item before or after matched buyers and sellers of the item and allowing broader participation in transacting the purchase and sale of different items. A market-maker is a participant who enters a bid and/or offer on an item, thereby adding liquidity to that item. The market-maker may add such liquidity at the request of the trading system, end users, customers, the general market place or for any other appropriate reason.

Further details of the invention are described below in relation to FIGS. 1-4.

Referring to FIG. 1, exemplary system 100 for implementing the invention is shown. As illustrated, system 100, which may be an electronic trading system, may include one or more workstations 110. Workstations 110 may be local or remote, and are connected by one or more communications links 102 to computer network 103 that is linked via communications link 105 to server 120. Server 120 may be linked to back office clearing center 130 via communications link 107.

Server 120 may be any suitable server, processor, computer, data processing device, or combination of the same. Server 120 may be used to implement the governing logic that processes and executes orders and trades, and distributes trade and market information, including price and size information, to workstations 110. Computer network 103 preferably includes the Internet but may consist of any suitable computer network such as an intranet, a wide-area network (WAN), a local-area network (LAN), a wireless network, a digital subscriber line (DSL) network, a frame relay network, an asynchronous transfer mode (ATM) network, a virtual private network (VPN), or any combination of the same. Communications links 102 and 105 may be any communications links suitable for communicating data between workstations 110 and server 120, such as network links, dial-up links, wireless links, hard-wired links, etc. 0020Workstations 110 may be personal computers, laptop computers, mainframe computers, dumb terminals, data displays, Internet browsers, Personal Digital Assistants (PDAs), two-way pagers, wireless terminals, portable telephones, etc., or any combination of the same. Workstations 110 may be used by participants to enter bid, ask, buy and sell orders for the items being traded and view market activity corresponding to these items.

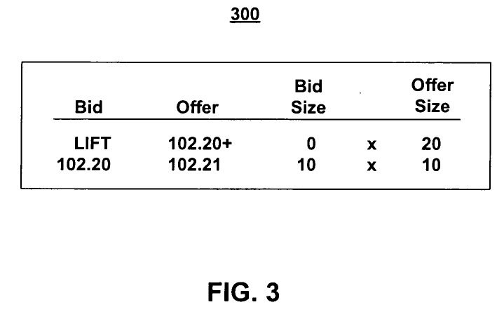

A typical workstation 110 may include processor 111, display 112, input device 113, and memory 114, which may be interconnected. In a preferred embodiment, memory 114 includes a storage device for storing a workstation program for controlling processor 111. The workstation program may include a trading application for displaying a trading interface, a portion of which is shown in FIG. 3 and displayed on display 112. Input device 113 may be used in conjunction with display 112 by users to enter bids/asks on desired items and to execute and monitor trades. Processor 111 may use the workstation program to receive trade information relating to the items being traded by multiple users of system 100, or other users, display such information on display 112 and communicate such information to server 120.

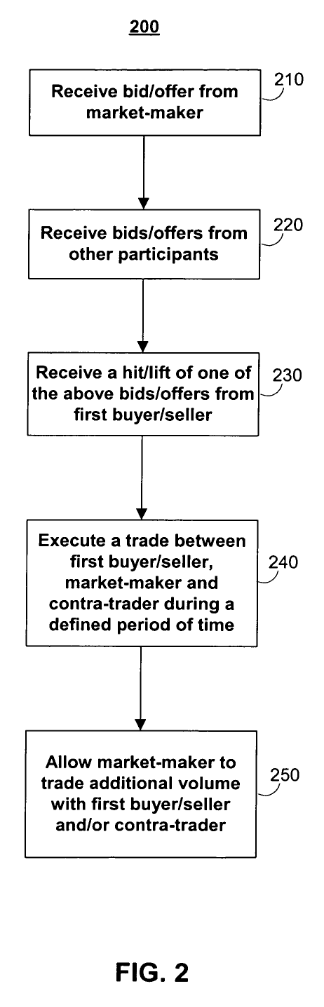

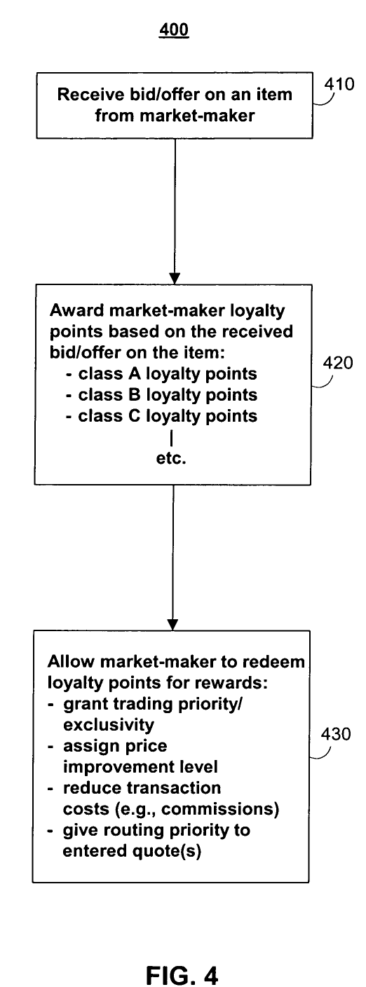

Server 120 may include processor 121, display 122, input device 123, and memory 124, which may be interconnected. In a preferred embodiment, memory 124 includes a storage device for storing a server program that provides the governing logic for controlling processor 121. The server program may include the controlling logic for rewarding market-makers and implementing processes 200 and 400 of FIGS. 2 and 4. Processor 121 may use the server program to process orders and execute trade commands communicated from various workstations that are operated by multiple users of system 100, or other users, and communicate trade information, as well as bid and ask information, to workstations 110 and back office clearing center 130. More specifically, processor 121 may use the server program to process orders placed by users in response to users entering commands using input device(s) 113, and execute trades based on such orders, whenever applicable.

Back office clearing center 130 may be any suitable equipment, such as a computer, a laptop computer, a mainframe computer, etc., or any combination of the same, for causing trades to be settled and/or verifying that trades are settled. Communications link 107 may be any communications links suitable for communicating data between server 120 and back office clearing center 130, such as network links, dial-up links, wireless links, hard-wired links, etc.

A Participant may input a bid and/or offer on a particular instrument through a predisposed workstation, such as workstation 110 of FIG. 1. Each bid or offer specifies the price at which the participant is willing to buy or sell an issue of the instrument. In addition, each bid or offer may specify the size of the proposed trade—i.e., the dollar volume of the pending bid/offer.

Any bid or offer, when entered, may only be available to current market participants. In other words, only those customers with current participation may lift or hit these bids/offers. Such a provision rewards participants for showing the market on their side by giving them the ability to make decisions with respect to pending bids and offers while preventing new buyers and sellers from entering into the market. Such participants may include market-makers. FIG. 2 illustrates another method for rewarding participants such as market-makers.

FIG. 2 illustrates a process 200 that may be implemented by server 120 of FIG. 1. At step 210, a market-maker may enter a bid and/or offer on a particular instrument that is received by the trading application implemented on system 100 of FIG. 1. At step 220, other participants may enter bids and offers on the same or another instrument that are received by the trading application. At step 230, a first buyer or seller participant, who may be referred to as an aggressor, may enter a trading command that is received by the trading application to hit or lift at least a portion of the entire volume that is made available in one of the bids and offers received in step 220.

At step 240, a trade may be executed between the first buyer/seller, the participant who placed the bid or offer that was hit or lifted—i.e., contra-trader—and potentially the market-maker for the entire volume made available. A time period during which semi-exclusive rights to the trade may or may not be given to the first buyer/seller to trade the instrument with the contra-trader at step 240. Similarly, a time period during which semi-exclusive rights to the trade may or may not be given to a market-maker according to the present invention at step 240.

More specifically, the market-maker may presented with the opportunity to trade a portion of the volume made available with the first buyer/seller or the contra-trader at step 240. The market-maker may be allowed to trade that portion before or after the first buyer/seller or contra-trader. For example, the first buyer/seller may trade a portion of the volume available with the contra-trader, whereas the market-maker may trade the remaining portion with the contra-trader. The market-maker may or may not be given priority to trade with the contra-trader over the first buyer/seller. Alternatively, the first buyer/seller may trade a portion of the volume available with the contra-trader, whereas the market-maker may trade the remaining portion with the first buyer/seller. The market-maker may or may not be given priority to trade with the first buyer/seller over the contra-trader.

At step 250, the market-maker may be given the opportunity to trade additional volume with the first buyer/seller, the contra-trader or any other participant. The market-maker may be given priority to trade the additional volume with any participant, including the first buyer/seller, over the contra-trader. Alternatively, the market-maker may be given priority to trade the additional volume with any participant, including the contra-trader, over the first buyer/seller. Preferably, only the first buyer/seller and the market-maker may be given the opportunity to share whatever additional volume the contra-trader may be willing to trade. Alternatively, following the contra-trader's termination of rights, the first buyer/seller or market-maker may trade additional volume with another participant according to the present invention. Either the first buyer/seller or the market-maker may transact additional trading volume with the contra-trader to the exclusion of outside customers during a defined time period. Preferably, if the contra-trader's bid is hit by the first seller, the market-maker, who placed an initial bid and offer (a two-way price) on the instrument, is allowed to sell additional volume to the contra-trader either prior to or immediately after the first seller. If two different market-makers placed a bid and offer, respectively, the one who placed the initial offer on the instrument is allowed to sell additional volume to the contra-trader either prior to or immediately after the first seller.

Similarly, if the contra-trader's offer is lifted by the first buyer, the market-maker who placed an initial bid and offer on the instrument may be allowed to buy additional volume from the contra-trader either prior to or immediately after the first buyer. If two different market-makers placed the initial bid and offer, the one who placed the initial bid on the instrument may be allowed to buy additional volume from the contra-trader either prior to or immediately after the first buyer.

Such provisions further reward market-makers by allowing them to be among the first participants allowed to transact additional volume that was untraded by first buyers/sellers at the current price while preventing other buyers and sellers from trading at that price on the market. In the event that some volume made available subsequently remains untraded, other users beyond the first buyer/seller and the market-maker may transact the purchase and sale of remaining volume.

In some embodiments of the present invention, the market-maker may be required to meet certain conditions in order to qualify for transacting a portion of the entire volume traded or transacting additional volume with the contra-trader. For example, not only may the market-maker input a bid/offer on an instrument, the price input by the market-maker may also be required to be within a predetermined range around the price of the bid or offer that was hit or lifted.

Moreover, the market-maker may be allowed to transact additional volume with the contra-trader, or transact a portion of the entire volume traded, either publicly to all participants—i.e., with an indication—e.g., a displayed visual indicator—that the additional volume posted by the contra-trader was traded with the market-maker—or privately—i.e., without any indication that the additional volume posted by the contra-trader was traded with the market-maker. Alternatively, the transaction of additional volume with the contra-trader, or a portion of the entire volume traded, may be made known only to the market-maker and the party with whom the market-maker chooses to transact such volume.

The above logic may be better understood in the context of the following example discussed in connection with FIG. 3. FIG. 3 shows a portion 300 of an interactive display that may be associated with electronic trading of any items including financial instruments, such as equity instruments, interest-rate-related instruments, and derivates thereof. Assume that after market-maker A places a bid of 102.20 and an offer of 102.21 for 10 million on a particular instrument, participant B makes a lower offer of 102.20+ for 20 million on the same instrument. This lower offer may be lifted by first buyer C who wishes to buy the entire volume offered by participant (or contra-trader) B. In accordance with the present invention, market-maker A is allowed to become a joint buyer on the trade at 102.20+ for a defined time period on account of his original making of the market. Accordingly, while first buyer C purchases a portion of the 20 million made available by participant B, market-maker A may purchase the remaining portion from participant B. Alternatively, market-maker A is allowed to become a joint seller on the trade at 102.20+ for a defined time period on account of his original making of the market. Accordingly, while first buyer C purchases a portion of the 20 million from participant B, market-maker A may sell the remaining portion to first buyer C.

Assuming instead that first buyer C does not lift the entire volume offered by participant B, market-maker A is allowed to become a joint seller on the trade at 102.20+ for a defined time period on account of his original making of the market in accordance with the present invention. Accordingly, while first buyer C purchases a portion of the volume he lifted from participant B, market-maker A may sell the remaining portion to first buyer C.

After the defined time period has passed, market-maker A may be may be allowed to buy additional volume proposed by any participant, including participant B, prior to first buyer C in accordance with the present invention. Market-maker A may be given direct priority to buy additional volume from participant B after first buyer C has concluded trading with participant B. Alternatively, market-maker A may buy additional volume from participant B after first buyer C has been given the opportunity to buy additional volume from participant B.

Referring back to FIG. 2, in other embodiments of the present invention, a market-maker may be given the opportunity to participate in transacting various instruments, by making a market in particular instruments. For example, in return for making a market in a relatively illiquid instrument at step 210, a market-maker may be given the opportunity to exclusively trade a different and more liquid and/or more desirable instrument at step 240. Moreover, the market-maker may be given the opportunity to exclusively trade additional volume of the other instrument at step 250. Such provisions further reward market-makers by giving them broader opportunities to transact in the purchase and sale of various instruments.

Such provisions may be implemented by providing incentives such as reward or loyalty points that a participant may accumulate each time he or she makes a market for a particular instrument, as shown in FIG. 4. FIG. 4 illustrates another process 400 that may be implemented by server 120 of FIG. 1 for rewarding market-makers. At step 410, a market-maker may enter a bid and/or offer on a particular instrument or item that is received by the trading application implemented on system 100 of FIG. 1. At step 420, the market-maker may be awarded loyalty points based on the bid/offer on the item. These loyalty points may be divided into different classes or classifications of points, each having specific restrictions or being associated with a particular type of reward that may be provided to the market-maker, as discussed further below.

The number of loyalty points earned, the class of points, or both, may depend on the type of instrument for which the market was made, the grade of the instrument, the volatility of the instrument, the liquidity of the instrument, the time of day during which the market for the instrument was made, how long the market-maker bid/offer has been available, how much trading volume was directly attributable to the participation of the market-maker, any combination thereof, or any other appropriate consideration. For example, the less liquid the instrument for which a participant makes a market, the more points awarded to the market-maker. Similarly, if a participant makes a market at a time of day during which there is very little trading activity, he or she may be awarded loyalty points pertaining to a more desirable class of points.

At step 430, the market-maker may be allowed to redeem the loyalty points he or she received for a particular type of reward that may be based on the classification of these loyalty points. For example, class A loyalty points may allow their holder to trade additional volume with the contra-trader after another participant has done so, whereas class B loyalty points may allow trading additional volume immediately after the first buyer/seller and class C loyalty points may allow trading additional volume prior to the first buyer/seller. Similarly, class A loyalty points may allow their holder to trade additional volume with the first buyer/seller after another participant has done so, whereas class B loyalty points may allow trading additional volume immediately after the contra-trader and class C loyalty points may allow trading additional volume prior to the contra-trader.

Moreover, certain restrictions may apply to different classes of loyalty points. For example, class A loyalty points may be restricted for use by the market-maker to whom they were awarded, whereas class B loyalty points may be assignable or transferable to certain participants and class C loyalty points may be publicly traded.

Loyalty points may be redeemed for the ability to improve on the price of particular instruments within predetermined pricing increments using price improvement (PI) at step 430 of FIG. 4. Using price improvement, participants may submit orders that improve on a price for a particular item at an amount less than a predetermined pricing increment. This amount may be referred to as a price improvement level. Dynamic price improvement allows an order to maintain a predetermined position (e.g., the front of the stack) within a trading stack regardless of other orders. Dynamic price improvement achieves this by adjusting the price improvement level of that particular order using smaller price increments that depend on the level of price improvement. For example, a dynamic order may initially be assigned a PI level of 1 to “jump” in front of another order, but its PI level may be adjusted (e.g., increased) as necessary to maintain its position in the front of the stack. Price improvement and dynamic price improvement are described in co-pending commonly assigned U.S. patent application Ser. No. 10/171,009, filed Jun. 11, 2002 and U.S. patent application Ser. No. 10/826,779 filed Apr. 16, 2004, which are hereby incorporated by reference herein in their entireties. For example, class A loyalty points may be redeemed for level 1 PI status, whereas class B loyalty points may be redeemed for level 2 PI status and class C loyalty points may be redeemed for a dynamic BEST PI level.

Alternatively, loyalty points may be redeemed for rewards other than priority or exclusivity in trading, as discussed, for example, in connection with FIGS. 2 and 3. Loyalty points may be redeemed for various trading privileges including reduced or no transaction costs, payment of a fixed amount of money, transaction based payments, etc. at step 430 of FIG. 4. For example, class A loyalty points may not provide their holders with savings relating to the commission payable by them, whereas class B loyalty points may provide their holders with discounts on commission payments and class C loyalty points may excuse their holders from paying a commission on a particular transaction altogether.

The present invention may be implemented in the trading of different goods and services and may be used in conjunction with goods and services that may trade in both exclusive and non-exclusive markets. In some embodiments of the present invention, bid/offer priority may be given to market-makers quoting and trading in equity markets.

A well-known equities exchange that utilizes market-makers to make markets is the National Association of Securities Dealers' Automated Quotation system (NASDAQ) exchange. Particularly, market-makers post their bid and ask (offer) prices for a stock or security to the NASDAQ. If a specific market-maker's posted bid or ask quote is the BEST quote for a security then the specific market-maker's quote is publicly displayed as the NASDAQ public quote for that security. Securities in the NASDAQ exchange trade at these public quotes. To facilitate the functionality of the NASDAQ, market-makers are electronically networked together in electronic communications networks (ECNs). Each ECN may sort its market-maker quotes and determine which quote to route for each instrument to an order center that sorts incoming quotes from the different ECNs and posts the BEST bid and the BEST ask independently.

In determining which quote to route, the controlling logic within each ECN typically gives priority to the quotes having the highest bid prices and the lowest ask price. If two or more different market-makers provide the same quote price, priority is usually given to the quote that was received first in time. If it is determined that the equal-price quotes were posted by market-makers substantially simultaneously, priority is given to the quote with the larger size.

According to the present invention, market-makers who have contributed to improving liquidity in less desirable, lucrative or liquid equities may be given priority over other participants or market-makers at step 430 of FIG. 4. More specifically, when a quote posted by such a market-maker is found to be equal in price to that of another market-maker trading in more desirable, lucrative or liquid equities, the former quote may be routed and posted by the ECN regardless of whether it was received prior to or after the latter quote. Alternatively, when the former quote is found to be equal in price and to have been received no later than the latter quote, the former quote may be routed and posted by the ECN regardless of the respective sizes of such quotes.

In other embodiments of the present invention, market-makers who have accumulated more loyalty points by making markets, receiving such points or buying them, may be given routing priority over market-makers with a lower number of points, less desirable class of points, or no points at all at step 430 of FIG. 4. For example, a quote posted by a market-maker holding class C loyalty points may be given priority over a similarly-priced quote placed by a market-maker holding class A or B loyalty points, a market-maker holding a smaller number of class C loyalty points and a market-maker holding no points at all. Similarly, a quote posted by a market-maker holding class B loyalty points may be given priority over a similarly-priced quote placed by a market-maker holding class A loyalty points, a market-maker holding a smaller number of class B loyalty points and a market-maker holding no points at all.

Moreover, the class of points held by a market-maker making a quote may determine whether routing priority will be given to that quote over another comparably-priced quote having a larger size or being received prior to the former quote at step 430 of FIG. 4. For example, a quote posted by a market-maker holding class A loyalty points may be given priority over a similarly-priced quote received substantially simultaneously. Similarly, a quote posted by a market-maker holding class B loyalty points may be given priority over a similarly-priced quote. Also, a quote posted by a market-maker holding class C loyalty points may be given priority over all other quotes.

One of ordinary skill in the art should appreciate that the present invention may be practiced in embodiments other than those illustrated herein. For example, the control logic described herein may be applied to any kind of trading system or exchange such as auction trading systems, interactive matching systems, automated matching systems, price improvement systems, FIFO (First In, First Out) systems, RFQ (Request for Quote) systems, etc., and may be applied to the trading of any types of items.

It will be understood that the foregoing is only illustrative of the principles of the invention, and that various modifications can be made by those skilled in the art without departing from the scope and spirit of the invention, and the invention is limited only by the claims that follow.

1. A method implemented on an electronic trading system, the method comprising:
receiving a bid or offer from a market-maker on an instrument;
receiving a bid or offer from a first participant on the instrument;
receiving a trading command to transact a desired volume of the instrument from a second participant at a defined price;
executing a trade between the first and second participants for at least a portion of the desired volume at the defined price during a defined period of time; and
presenting the market-maker with an opportunity to participate in trading at least another portion of the desired volume with the first or second participant at the defined price to the exclusion of other participants during the defined period of time.

2. The method of claim 1 further comprising executing a trade between the market-maker and the first or second participant for the at least another portion of the desired volume at the defined price to the exclusion of other participants during the defined period of time.

3. The method of claim 2 wherein the executing the trade between the market-maker and the first or second participant comprises executing a trade between the market-maker and the first participant for a portion of the desired volume that was not traded between the first participant and the second participant.

4. The method of claim 2 wherein the executing the trade between the market-maker and the first or second participant comprises executing a trade between the market-maker and the second participant for a portion of the desired volume that was not traded between the first participant and the second participant.

5. The method of claim 1 wherein the market-maker is given priority over the first participant to trade the at least another portion of the desired volume of the instrument with the second participant.

6. The method of claim 1 wherein the market-maker is given priority over the second participant to trade the at least another portion of the desired volume of the instrument with the first participant.

7. The method of claim 1 further comprising, after the defined period of time has passed, allowing the market-maker to trade additional volume of the instrument with any participant.

8. The method of claim 7 wherein allowing the market-maker to trade additional volume comprises allowing the market-maker to trade additional volume of the instrument with any participant either prior to or immediately after the second participant.

9. The method of claim 7 wherein allowing the market-maker to trade additional volume comprises allowing the market-maker to trade additional volume of the instrument with any participant either prior to or immediately after the first participant.

10. The method of claim 1 wherein presenting the market-maker with an opportunity to participate in trading the at least another portion of the desired volume depends on a price of the bid or offer received from the market-maker.

11. The method of claim 7 wherein allowing the market-maker to trade additional volume depends on a price of the bid or offer received from the market-maker.

12. The method of claim 2 wherein executing the trade between the market-maker and the first or second participant is made public to all participants.

13. The method of claim 2 wherein executing the trade between the market-maker and the first or second participant is made known to only the market-maker and either the first or second participant.

14. The method of claim 7 wherein allowing the market-maker to trade additional volume is made public to all participants.

15. The method of claim 7 wherein allowing the market-maker to trade additional volume is made known to only the market-maker and a participant with whom the market-maker chooses to trade additional volume.

16. A method implemented on an electronic trading system, the method comprising:
receiving a bid or offer from a market-maker on a first item;
granting the market-maker a plurality of reward points based on the received bid or offer; and
presenting the market-maker with an opportunity to redeem at least a portion of the plurality of reward points by participating in trading at least a portion of a desired volume of a second item with a first participant or a second participant at a defined price, the first participant having entered a bid or offer for the desired volume at the defined price on the second item, the bid or offer being traded by the second participant.

17. The method of claim 16 wherein the second comprises the first item.

18. The method of claim 16 further comprising executing a trade between the first and second participants for at least another portion of the desired volume at the defined price.

19. The method of claim 18 wherein the at least another portion of the desired volume comprises a portion of the desired volume that was not traded between the market-maker and the first or second participant.

20. The method of claim 18 further comprising executing a trade between the market-maker and the first or second participant for the at least a portion of the desired volume prior to executing the trade between the first and second participants.

21. The method of claim 16 wherein the number of the plurality of reward points depends on a consideration that is selected from the group consisting of a type of the first item, a grade of the first item, a volatility of the first item, a liquidity of the first item, a time of day during which the bid or offer was received, how long the bid or offer has been available, how much trading volume was directly attributable to a participation of the market-maker and any combination thereof.

22. The method of claim 16 wherein the plurality of reward points pertain to a particular classification.

23. The method of claim 22 wherein the classification depends on a consideration that is selected from the group consisting of a type of the first item, a grade of the first item, a volatility of the first item, a liquidity of the first item, a time of day during which the bid or offer was received, how long the bid or offer has been available, how much trading volume was directly attributable to a participation of the market-maker and any combination thereof.

24. The method of claim 22 wherein the classification of the plurality of reward points allows the market-maker to participate in trading the at least portion of the desired volume with the first participant either prior to or immediately after the second participant.

25. The method of claim 22 wherein the classification of the plurality of reward points allows the market-maker to participate in trading the at least portion of the desired volume with the second participant either prior to or immediately after the first participant.

26. The method of claim 20 wherein the executing the trade between the market-maker and the first or second participant is made public to all participants.

27. The method of claim 20 wherein the executing the trade between the market-maker and the first or second participant is made known to only the market-maker and either the first or second participant.

28. The method of claim 22 wherein the classification of the plurality of reward points allows only the market-maker to redeem the plurality of loyalty points.

29. The method of claim 22 wherein the classification of the plurality of reward points allows the market-maker to transfer the plurality of loyalty points to another participant.

30. The method of claim 22 wherein the classification of the plurality of reward points allows for the public trading of the plurality of loyalty points.

31. A method implemented on an electronic trading system, the method comprising:
receiving a bid or offer from a market-maker on an item;
granting the market-maker a reward having a particular class, the class being based on the received bid or offer; and
presenting the market-maker with an opportunity to redeem the reward by ensuring that an order placed by the market-maker maintains a predetermined position within a trading stack using price increments, the price increments being based on the class of the reward.

32. The method of claim 31 wherein the class of the reward depends on a consideration that is selected from the group consisting of a type of the item, a grade of the item, a volatility of the item, a liquidity of the item, a time of day during which the bid or offer was received, how long the bid or offer has been available, how much trading volume was directly attributable to a participation of the market-maker and any combination thereof.

33. A method implemented on an electronic trading system for receiving and prioritizing quotes related to financial instruments, the method comprising:
receiving a bid or offer quote from a market-maker on a financial instrument;
granting the market-maker a reward having a particular class, the class being based on the received bid or offer quote; and
presenting the market-maker with an opportunity to redeem the reward by granting the bid or offer quote priority over other quotes relating to the financial instrument based on the class of the reward.

34. The method of claim 33 wherein the class of the reward depends on a consideration that is selected from the group consisting of a type of the financial instrument, a grade of the financial instrument, a volatility of the financial instrument, a liquidity of the financial instrument, a time of day during which the bid or offer quote was received, how long the bid or offer quote has been available, how much trading volume was directly attributable to a participation of the market-maker and any combination thereof.

35. An electronic trading system comprising a server that is coupled to a plurality of workstations, each of the workstations being adapted to communicate trading information relating to at least one instrument with the server, the server being adapted to:
receive a bid or offer from a market-maker on the at least one instrument;
receive a bid or offer from a first participant on the at least one instrument;
receive a trading command to transact a desired volume of the at least one instrument from a second participant at a defined price;
execute a trade between the first and second participants for at least a portion of the desired volume at the defined price during a defined period of time; and
present the market-maker with an opportunity to participate in trading at least another portion of the desired volume with the first or second participant at the defined price to the exclusion of other participants during the defined period of time.

36. An electronic trading system comprising a server that is coupled to a plurality of workstations, each of the workstations being adapted to communicate trading information relating to at least a first and a second item with the server, the server being adapted to:
receive a bid or offer from a market-maker on a first item;
grant the market-maker a plurality of reward points based on the received bid or offer; and
present the market-maker with an opportunity to redeem at least a portion of the plurality of reward points by participating in trading at least a portion of a desired volume of a second item with a first participant or a second participant at a defined price, the first participant having entered a bid or offer for the desired volume at the defined price on the second item, the bid or offer being traded by the second participant.

37. An electronic trading system comprising a server that is coupled to a plurality of workstations, each of the workstations being adapted to communicate trading information relating to at least one item with the server, the server being adapted to:
receive a bid or offer from a market-maker on the at least one item;
grant the market-maker a reward having a particular class, the class being based on the received bid or offer; and
present the market-maker with an opportunity to redeem the reward by ensuring that an order placed by the market-maker maintains a predetermined position within a trading stack using price increments, the price increments being based on the class of the reward.

38. An electronic trading system for receiving and prioritizing quotes related to financial instruments, the system comprising a server that is coupled to a plurality of workstations, each of the workstations being adapted to communicate trading information relating to at least one financial instrument with the server, the server being adapted to:
receive a bid or offer quote from a market-maker on the at least one financial instrument;
grant the market-maker a reward having a particular class, the class being based on the received bid or offer quote; and
present the market-maker with an opportunity to redeem the reward by granting the bid or offer quote priority over other quotes relating to the at least one financial instrument based on the class of the reward.
